(19) United States
(12) Patent Application Publication
(10) Pub. No.: US 2019/0161369 A1
(43) Pub. Date: May 30, 2019

(54) Mountable chamber to condition water

(71) Applicant: Decauter Stoppelbein, Mount Aukum, CA (US)

(72) Inventor: Decauter Stoppelbein, Mount Aukum, CA (US)

(21) Appl. No.: 15/821,850

(22) Filed: Nov. 24, 2017

(51) Int. Cl. C02F 1/48; C02F 1/00

(52) U.S. Cl. CPC C02F 1/482; C02F 1/005

(57) ABSTRACT

Apparatus for improving the characteristics of water and water-bearing substances, which may be easily mounted to a water discharge point, being a housing chamber with mountable connections for easy installation, portability, and application, for use on bottles, hoses, faucets, inline arrangements, or other applications, in which water can flow over and around a plurality of solid-state materials, which have demonstrated sufficient structural interface activity and interactions to alter the characteristics and properties of water, such as certain gemstones, crystalline, ceramic, or magnetic materials, arranged within a housing, with retention elements to hold the materials within, which may be designed to facilitate the movement and flow pattern of the water, such as honeycomb apertures, and which may include mechanical or magnetic compression. The result is water that has improved taste, characteristics, and qualities, with an easily mountable and interchangeable apparatus, may be designed to be portable or disposable, and convenient.

### CROSS-REFERENCE TO RELATED APPLICATIONS

N/A

### STATEMENT REGARDING FEDERALLY SPONSORED RESEARCH AND DEVELOPMENT

N/A

### BACKGROUND OF THE INVENTION

### 1. Field of the Invention

This invention relates generally to the conditioning of water and the improvement of the characteristics, taste, and experience of water's qualities. More specifically, the invention relates to the process of producing improved qualities of water having useful properties in a variety of environments, through affecting the structural interface naturally inherent in water through the exposure of solid-state materials that have been shown to provide sufficient structural interface activity and interactions to affect the characteristics of water, such as gemstones and crystalline or magnetic materials, by imparting to water interface activity which the water does not normally posses.

### 2. Summary of Prior Art

There has been a growing demand to improve the characteristics, taste, and experience of water quality. It has been shown that the changes in the characteristics, taste, and properties of water can occur by affecting the structural interface activity inherent in associated water molecules, which allows for dynamic changes in the bonding types associated with individual water molecules and water molecule clusters, which occur primarily in hydrogen bonding between un-bonded molecules, tetra-hydrogen bonded molecules, surface molecules connected to individual molecule clusters, as well as van der waal bonds, or the intermolecular forces that exists between the millions of separate water molecules. These natural clustering and changes in the structural interface activity can be short lived and unpredictable, however it has been shown passing water through various movements, over various materials or minerals, or in exposure to magnetic fields can condition water to improve its characteristics and taste. Several technologies and products have been created to condition water and affect its characteristics, such as imparting specific movement to water, or exposing it to magnetic fields or negative ions to impart effect on the inherent quality of water to affect its structural interface. These devices are currently difficult to install, requiring large spaces or permanent placement and plumbing, have unpredictable interface action that is often short lived, are often not usable at discharge points causing reduction in conditioning benefit as it travels through plumbing before use, are specific to limited use, such as showerheads or sink plumbing, use large amounts of media which is often fine grain thus reducing water flow rates and making for heavy devices. There is a need for devices that are easier to install and use, are more transportable, can be outfitted at water discharge points for immediate consumption or use, can be adaptable and interchangeable for multiple use with one device, and can be scaled down to sizes appropriate for standard drinking bottle caps, nozzles, and faucet taps while still imparting to water an interface activity that improves the characteristics, taste, and experience of water quality, may be scaled down further for drippers in use such as agriculture or hydroponics, or scaled up for larger applications. Magnetic fields have been shown to affect the bonding arrangements within water, and minerals have been shown to improve the taste, qualities, and health benefits of water. Certain materials such as composites and ceramics have also demonstrated use in the conditioning of water through actions such as infrared and negative ion emissions, as well as gemstones and crystals which has also been observed as being highly beneficial. Gemstones and crystals have long been said to provide unique benefits to human health and wellbeing, and it is theorized this is due to the unique relationship gemstones and crystals have to the liquid crystallographic structural interface present in water. Additional effects to the organization and structural interface activity of the water molecules can be obtained by utilizing the properties of certain materials, such as piezoelectric properties of quartz and tourmaline when compressed, or infrared emissions and ionic activities of certain materials and minerals, to further generate structural interference action in the activity naturally present in water. Additionally, minerals and stones such as maifanite, tourmaline, certain ceramics, and others have been shown to improve the quality of water. By creating an apparatus that imparts the interface activity interaction of water with the solid-state materials such as gemstones, crystalline, ceramic, magnetic, and other such materials in a way that is more reasonable, convenient, reusable and disposable in portable embodiments, which may not require permanent installation, and which may have changeable adapter fittings for interchangeable use, and easy to scale for multiple applications while still imparting to water the interface action necessary to improve the characteristics, taste, and qualities, this invention solves the problems of current market options.

### SUMMARY OF THE INVENTION

The present invention provides several embodiments of a water conditioning apparatus to solve the above problems and disadvantages while providing at least the advantages described hereinafter. Namely, the creation of an optimal mountable device for affecting the structural interface activity inherent in water, through an apparatus that can be easily mountable, convenient, transportable, easy to use and does not require permanent installation, may be reusable or disposable when manufactured for small embodiments such as bottle cap applications, which may have changeable adapter fittings for interchangeable use to easily accommodate a variety of uses with one adaptable device, can use small volume load materials, which may be used at water discharge points such as hose ends, taps, bottle caps, and otherwise, which may be easily scalable and adaptable for multiple applications and embodiments, and which may provide instant changes in the structural interface activity of water molecule clustering to improve the characteristics, taste, and quality of water, or any water-bearing substance that benefits from conditioning or structural interface activity, for use or consumption.

To achieve at least the above objective and other advantages in whole or in part and in accordance with the purpose of the present invention, as embodied and broadly described herein, there is provided a mountable apparatus that may be mounted directly at a water discharge point or in inline water supply arrangements in various embodiments, being a housing chamber with mountable connection ends which may be present on either or both sides of the unit, which may accommodate changeable adapter fittings for interchangeable use, adaptability, and portability, allowing for preferred application use at discharge point, which may accommodate bottles, bottle caps, hoses, faucet taps, spigots, drippers, inline arrangements, or other such desired applications, and which may be easily scaled for various application environments, and which does not require permanent installation, to condition water or water-bearing substances to improve its characteristics for a variety of environments and applications, by providing sufficient structural interface activity and interactions to improve the characteristics, taste, and quality of the water or water-bearing substances, by allowing it to pass through a unit of various embodiments which may be mountable to a discharge point, having in inlet and an outlet which may be mountable at either or both ends for any suitable connection or adapter fitting, through which a liquid, preferably water, may enter one side and exit the other, after passing through a plurality of solid-state natural or synthetic materials that have been shown to condition water or provide sufficient structural interface activity and interactions to improve the characteristics of water, such as gemstones, crystalline, mineral, metal, magnetic materials, ceramics, composites, infrared or negative ion emitting materials, or otherwise, wherein said materials are of a plurality, volume, and predetermined size consistent with small volume load material relative to application size and flow rate, held within the housing with perforated screens or barriers mounted across the unit at both ends of flow passage, the apertures of which are sized smaller than the smallest unit of material inside or arranged in such a way to prevent said material from dislodging during flow passage while maintaining consistent movement for structural interface action and ample flow rate. Solid-state materials held within the housing chamber may be placed under mechanical or magnetic compression by using the retention elements coupled with the housing sides for increased or desired structural interface action and activation of material properties, such as piezoelectricity or other such changes in properties of materials within the housing, or be loose to create agitation and collision structural interface activity depending on the materials used. Retention element barriers or perforated screens may be designed to affect the flow rates and pattern of the water with the interaction of the materials inside or upon discharge and magnetic field exposure, magnetic compression, or magnetic interaction with materials inside may be added through the inclusion of magnets on the exterior or interior of the housing This invention allows for various embodiments of an optimal mountable water conditioning apparatus which may be portable and interchangeable for adaptable use to successfully affect the characteristics of water or increase and affect the structural interface activity inherently present in water.

### BRIEF DESCRIPTION OF THE DRAWINGS

The invention will be described in detail with reference to the following drawings in which lie reference numerals which refer to like elements wherein:

FIG. 1 is a cross-sectional side view of an embodiment of a mountable water conditioning apparatus of the invention.

FIG. 2 is a cross-sectional side view of an embodiment of the mountable water conditioning apparatus of the invention for a bottle;

FIG. 3 is a cross-sectional side view of another embodiment of the mountable water conditioning apparatus of the invention for a bottle;

FIG. 4 is a cross-sectional side view of another embodiment of the mountable water conditioning apparatus.

### DETAILED DESCRIPTION OF THE INVENTION

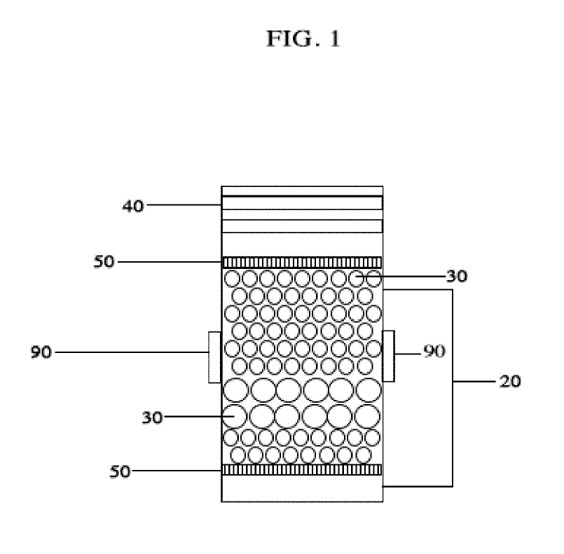

The present invention relates to a mountable and adaptable apparatus that can be mounted to a water discharge point and may be interchangeable, being a housing chamber with mountable connection ends capable of conditioning water or water-bearing substances to improve it's characteristics. Apparatus is easy to install or scale for various embodiments of the invention, having mountable connection ends that allow for quick and easy install at water discharge points such as a hose end, faucet tap, or otherwise, with embodiments which allow for mountable connection ends on both the water inlet and water outlet ends of the apparatus, allowing for any suitable connection fitting to be made for adding a spigot, nozzle, closed top, or other desired connection fitting, also allowing the apparatus to be used in inline arrangements or to be made for easy accommodation and portability for standard bottle tops and other such applications, and which may have changeable adapter fittings for interchangeable use to accommodate a variety of applications with one adaptable device. Referring to FIG. 1, there is illustrated a first embodiment of the apparatus of the invention for use at water discharge points such as, but not limited to hose, faucet, drip line, or otherwise, consisting of a housing chamber, generally designated by reference numeral 20, which contain materials held within generally designated by reference numeral 30. Said materials 30 refer to solid-state materials that demonstrate the desired properties when providing structural or magnetic interference action in accordance with the invention, such as gemstones, crystalline, ceramic, mineral, metal, and magnetic materials, such as but not limited to maifanite, tourmaline, quartz, infrared and negative ion emitting materials, gold, silver, or others to condition water to improve it's quality. Housing chamber 20 may be cylindrical in shape and having at least one mountable connection end 40 which may mount to any suitable adapter fitting for application use. Housing chamber 20 may consist of any usable material, whether steel, plastic, brass, glass. Pyrex, or otherwise. Mountable connection end 40 for water supply line may be made out of any suitable material and contain either an internal thread connection or external thread connection, and may us a gasket seal to prevent leaks in connection if necessary, or may be unthreaded and mounted using interference or compression fit, welding, glue, or otherwise in a suitable manner, or may be plug fittings or otherwise, may be connected to any suitable adapter fitting to accommodate changeable use, and may be connected to a water pipe discharge point, such as faucet, hose, bottle top, drip system, or likewise. A retention element generally designated by reference numeral 50 may consist of a barrier mounted across both ends of flow passage to prevent materials 30 within the housing chamber 20 from dislodging at supply or discharge points, this barrier 50 may be a perforated screen or otherwise where the apertures of the barriers are sized smaller than the smallest unit of material, or arranged in such a way to prevent said material from dislodging, while maintaining consistent movement for structural interference action and ample flow rate. Retention element 50 may be designed in such a way as to affect the flow rates and pattern of the water with the interaction of the materials inside or upon discharge, such as, but not limited to, honeycomb screens, and may also be made out of any suitable material, whether plastic, metal, or otherwise. Retention element 50 may be mounted in any suitable way within the housing chamber. Materials 30 may be placed under mechanical or magnetic compression by compression mount of retention element 50, compression to housing chamber 20 sidewalls, for increased structural interface action or activation of certain properties of materials 30 such as piezoelectricity in the case of quartz or tourmaline, or other such changes in properties of materials within the housing, or be loose to create agitation and collision structural interface activity depending on the materials used and their associated physical properties. Plurality, volume, and size of materials 30 shall be predetermined relative to application and flow rate needs, and consistent with small volume load relative to application size, maintaining minimum material required for demonstrating desired properties when placed in accordance with the invention. Additional magnetic materials 90 may be added to the exterior or interior of housing 20 or mountable end 40 for additional magnetic field interactions. Any components may additionally be silver plated or otherwise treated in a desired manner for additional effects such as antibacterial potential.

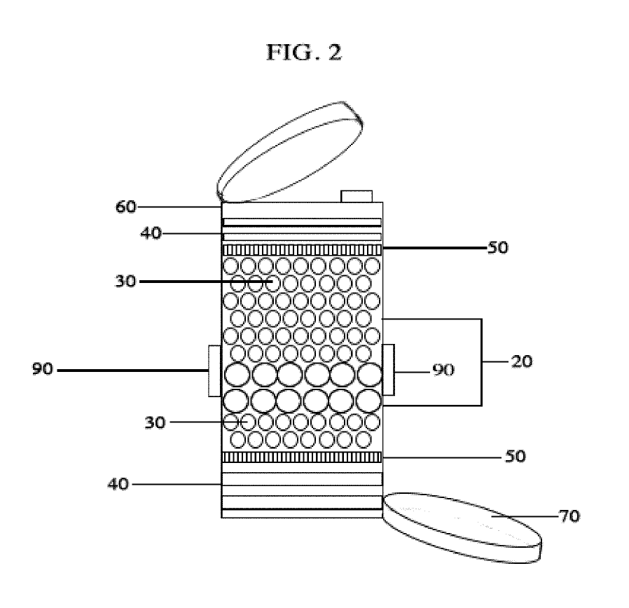

Referring to FIG. 2, there is illustrated an embodiment of the apparatus of the invention for use in a bottle type application. In the embodiment of FIG. 2, the mountable connection end 40 has internal threads which allow apparatus to easily mount to the top of a bottle while discharge mountable connection end 40 may be connected to an adapter fitting for bottle cap 60 while a bottom cover 70 is offered as an adaptable supply fitting, making the apparatus extremely portable and keeping the housing free of germs or debris during transportation. Bottle cap 60 and bottom cover 70 may be made out of any suitable material such as stainless steel, plastic, or otherwise. In the embodiment of FIG. 2, mountable connection end 40 corresponds to the proper depth and threading of desired bottle application with internal threads, providing room on the external mountable connection end for bottom cover 70 and additional magnets 90 if desired. Intake retention element 50 holds materials 30 within the housing 20, which also corresponds in size relative to intended use. At the discharge point of housing 20 there is mounted the discharge retention element 50, followed by a bottle lid 60 which allows for the consumption of the water or liquid and may provide a close top lid, which may be flipped closed as standard bottle caps. Bottle lid 60 may also be in the form of a top allowing passage of liquids through housing 20 and materials 30 and need not be a closed lid but may also be a modified drinking straw or be a molded or extruded hollow member.

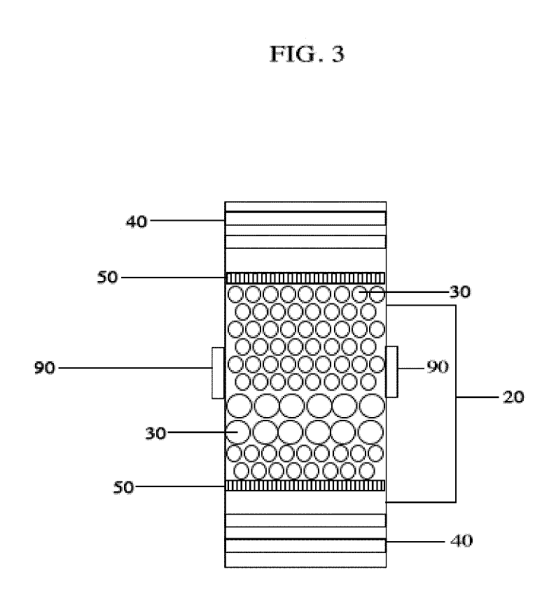

Referring to FIG. 3, an embodiment of the apparatus for use in an inline application, or in a bottle type application, or equipped with dual mountable ends for changeable adapter fittings or inline connection is shown, wherein the embodiment of the apparatus is similar to FIG. 2 excepting this embodiment does not use the flip closed bottle cap lid 60 of FIG. 2. Rather, this embodiment has dual mountable connection ends 40 at both the supply and discharge points of water on the housing 20, wherein the mountable end 40 on the water supply is the appropriate depth and threaded or not threaded as necessary to mount to the water supply source or to any suitable adapter fitting, while the opposite mountable connection end 40 at the discharge side is also threaded or not threaded to the appropriate depth and size to accommodate mounting to the water discharge point or any suitable adapter fitting. Water may discharge the apparatus to continue in the water supply conduit in the case of inline application, or may accommodate suitable adapter fittings for desired attachment such as a closed end or top, or a closed bottle top, or may accommodate a spigot, wand, dripper, sprayer, or any desired nozzle or connection fitting, or mountable connection ends 40 may be designed in such a way as to mount within plastic inline arrangement, as is the case in sports bottle straws or flexible inline water conduits, with or without adapter connections.

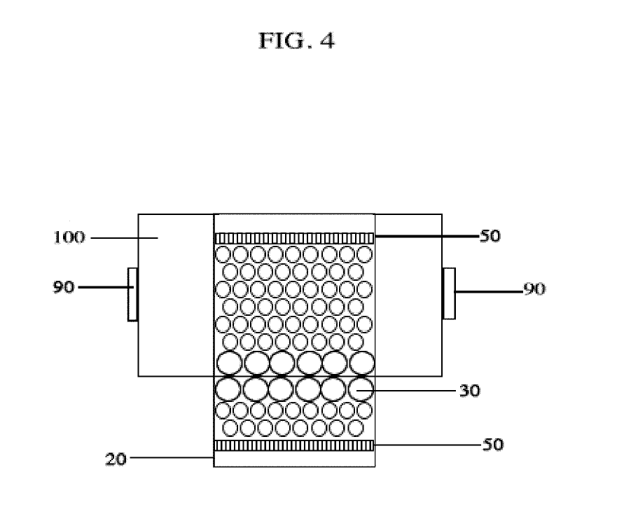

Referring to FIG. 4, another embodiment of the apparatus for use in another bottle type application or recessed apparatus is shown. In this embodiment, materials 30 encased in housing 20 can be recessed into the bottleneck or water supply intake line where recessed housing is preferred. In this embodiment shown in FIG. 4 the housing 20 is sized appropriately to recess into a bottle neck or water supply, and may be mounted in a suitable manner to a mountable connection end 100. Mountable connection end 100 is designed in such a way as to mount over the sleeve of the water supply pipe, tube, or bottle, while effectively recessing the housing 20 containing materials 30 within the bottle or supply line. Mountable connection end 100 may be scaled appropriately larger or smaller to fit desired application and may be threaded or unthreaded as necessary for apparatus, made of any suitable material. An embodiment of this type of the apparatus for use of the invention may have the mountable connection end 100 designed for use at a discharge point, or the mountable connection end 100 may have suitable connection necessary to allow for adapter fittings to mount at the discharge point to accommodate spigots, nozzles, straws, sprayers, continued inline use, or other such desired connection fitting.

1. An apparatus for improving the characteristics of liquid, comprising:
a mountable unit through which water or water-bearing substances may flow, which may be portable, reusable, potentially disposable, make use of interchangeable adapter fittings, be used at water discharge points, and which may not require permanent installation, containing solid-state natural or synthetic materials of a predetermined plurality and size, arranged within a housing chamber equipped with retention elements, to provide sufficient structural interface activity and interactions to alter the properties of water, such as gemstones, crystalline, mineral, and magnetic materials, wherein liquid may enter the unit on one side, passing through the mixture materials, and exit the unit on the other side, the hollow housing containing the mixture of materials which includes a means for retaining said materials within the unit and prevent any material loss during the supply or discharge of liquids passing through the unit.
The apparatus according to claim 1, wherein the unit-housing chamber consists of a hollow container such as a cylindrical tube,
The apparatus according to claim 1, wherein the housing chamber is filled with solid-state materials demonstrated to have the desired properties when used in accordance with this invention, such as gemstones, crystalline, mineral, metal, composite, ceramic, magnetic materials, or otherwise,
The apparatus according to claim 1, wherein the said materials within the housing chamber are retained within the unit by a retention element which may be perforated screens, the apertures of which are sized to prevent the passage of contained materials from the housing while maintaining consistent movement for structural interface action and ample flow rate, mounted across the unit at the flow supply and discharge openings, which may provide compression, and which may be designed in such a way as to facilitate flow pattern, such as honeycomb apertures, or any suitable barrier arranged in such a way as to prevent passage of the materials from the housing chamber,
The apparatus according to claim 1, wherein the housing chamber has mountable ends, which may be at both or either side of the apparatus, which may be affixed to the housing chamber in any suitable manner and which may be mountable by screw threads, weld, glue, plug, compression or interference fit, or any suitable manner, to allow the apparatus to be mounted to bottles, bottle tops, hoses, various taps, drip or water conduit or supply lines, or any other such desired application,
The apparatus according to claim 1, wherein the supply and discharge mounting ends may also be suitable for mounting any desired connection fitting attachment, such as a nozzle, drinkable tops, spray wands, drip lines, or otherwise, and wherein mountable ends at supply or discharge may points may also have changeable adapter fittings for interchangeable use or for use coupled in tandem,
The apparatus according to claim 1, wherein the housing chamber or mountable end or ends may have additional magnets of predetermined size and strength affixed to the exterior or included in the interior to provide specific patterns and strength of magnetic field exposure and interactions such as torsion, magnetic compression, and to create interacting fields between the magnets and magnetically conductive materials in the housing chamber.
